(19) United States
(12) Patent Application Publication
(10) Pub. No.: US 2026/0098524 A1
(43) Pub. Date: Apr. 9, 2026

(54) Food-processing machine

(71) Applicant: Provisur Technologies, Inc., Chicago, IL (US)

(72) Inventors: Ralph SINGENBERGER, Uzwil (CH); Marcel TWARDAWA, Winterthur (CH)

(73) Assignee: Provisur Technologies, Inc., Chicago, IL (US)

(21) Appl. No.: 19/271,038

(22) Filed: Jul. 16, 2025

(30) Foreign Application Priority Data
Oct. 8, 2024 (DE) 10 2024 128 902.3

(51) Int. Cl. F04B 1/324; A22C 7/00; F04B 1/16; F04B 17/03

(52) U.S. Cl. CPC F04B 1/324; A22C 7/0023; F04B 1/16; F04B 17/03; F04B 2205/06

(57) ABSTRACT

A food-processing machine for processing a food product is provided. The machine includes at least one hydraulically driven consumer, a hydraulic pump which delivers a hydraulic fluid for driving the consumer and supplies a specific system pressure of the hydraulic fluid, and a control device for specifying a desired mechanical output of the consumer, a specific minimum value of the system pressure being required in order to achieve the desired mechanical output of the consumer. In the control device, the system pressure supplied by the hydraulic pump is a function of the desired mechanical power of the consumer as required such that the hydraulic pump supplies only the required minimum value of the system pressure with a certain safety margin, but no more, in order to save drive energy for driving the hydraulic pump.

### TECHNICAL FIELD OF THE INVENTION

The invention relates to a food-processing machine for processing a food product, in particular for pressing the food product.

### BACKGROUND TO THE INVENTION

It is known from the state of the art to shape unevenly shaped food products (e.g. raw ham, raw meat) in a pressing device before a machine cutting process in order to achieve a better cutting result. For this purpose, the food product to be shaped is placed in a pressing chamber and then pressed in the pressing chamber by several displaceable pressing plates in several pressing axes in order to bring the food product into the desired shape.

U.S. Pat. No. 11,412,744 B2 discloses such a pressing device in which the movable pressing plates are each driven by a hydraulic drive cylinder. The drive cylinder is supplied with a certain system pressure of hydraulic oil by a hydraulic pump via a supply line, whereby the hydraulic oil can then be fed back into a tank via a return line. A pressing process is controlled by a proportional valve, which controls the flow of hydraulic oil through the supply line and through the return line. The system pressure of the hydraulic oil supplied by the hydraulic pump must be high enough to ensure that the pressing device can apply the required pressing force in all operating states. In many operating states of the pressing device, the hydraulic pump therefore supplies a system pressure that is not actually necessary at this level, but still consumes a corresponding amount of drive energy to drive the hydraulic pump. The mechanical drive of the hydraulic pump therefore leads to relatively high energy consumption, which is disruptive.

### DESCRIPTION OF THE INVENTION

The invention is therefore based on the task of reducing the energy consumption required to drive the hydraulic pump.

This task is solved by a food-processing machine according to the main claim.

In accordance with the prior art described above, the food-processing machine according to the invention initially has at least one hydraulically driven consumer. This is preferably a pressing device for pressing the food product with a hydraulic drive cylinder. However, the invention is not limited to such pressing devices, but can in principle also be realized in other types of food-processing machines, which have a hydraulically driven consumer.

Furthermore, in accordance with the prior art described above, the food-processing machine according to the invention has a hydraulic pump which delivers a hydraulic fluid (e.g. hydraulic oil) to drive the consumer and supplies a certain system pressure of the hydraulic fluid.

Furthermore, in accordance with the prior art described above, the food-processing machine according to the invention also has a control device that specifies a desired mechanical power of the consumer. For example, the control device can specify the desired process force (i.e. the sum of pressing force, acceleration force and friction force) of a hydraulic drive cylinder of the consumer. For example, pressing devices for pressing food products usually operate according to a predetermined travel profile, whereby the travel profile then specifies a certain course of position, speed and acceleration of the pressing plates and the resulting pressing force. However, the term “predetermined mechanical power” used in the context of the invention is to be understood generally and is not limited to such a travel profile of a mechanical pressing device. In this context, however, it should be mentioned that a certain minimum value of the system pressure of the hydraulic fluid is required to achieve the desired mechanical power of the consumer. In the state of the art described above, the system pressure of the hydraulic fluid is therefore selected so high that the desired mechanical power of the consumer can be realized in all operating states. In practice, the system pressure of the hydraulic fluid is therefore oversized in many operating states, which leads to correspondingly high additional consumption in the mechanical drive of the hydraulic pump.

The invention therefore provides for the control device to adjust the system pressure supplied by the hydraulic pump as required, depending on the desired mechanical power of the consumer, so that the hydraulic pump only supplies the required minimum value of the system pressure with a certain safety margin, but no more, in order to save drive energy for driving the hydraulic pump. Therefore, if only a low process force of the pressing device is required during a pressing operation, the system pressure of the hydraulic fluid can be lowered. If, on the other hand, a very high process force is required during a pressing operation, the system pressure can be increased accordingly so that the drive cylinder of a pressing device can generate the required process force. Setting and lowering the system pressure as required therefore enables energy to be saved when driving the hydraulic pump.

The above-mentioned concept of a safety margin is preferably realized by a safety factor. For example, the system pressure of the hydraulic fluid can be set so that it exceeds the calculated minimum value by 30%. Alternatively, however, it is also possible for the safety margin to be an absolute value, i.e. a specific pressure difference that is added to the calculated minimum value of the system pressure.

In one variant of the invention, the hydraulic pump has an adjustable rotary speed, whereby the control device adjusts the rotary speed of the hydraulic pump in order to adjust the system pressure of the hydraulic fluid supplied by the hydraulic pump. However, such variable-speed hydraulic pumps are relatively sluggish and therefore respond only correspondingly slowly to changes in the desired rotary speed or the desired system pressure.

Preferably, the hydraulic pump is therefore not a variable-speed pump, but a pump with an adjustable displacement volume (“variable displacement pump”), whereby the control device then adjusts the displacement volume of the hydraulic pump to set the system pressure supplied by the hydraulic pump.

In a preferred embodiment of the invention, an axial piston pump is used for this purpose, for example a swash plate machine or a swash axis machine. Such axial piston pumps are known per se from the prior art and therefore need not be described in more detail. However, it should be mentioned that the axial piston pump has several pistons, each of which is axially displaceable along a piston axis and is axially displaced by a sliding disk, whereby the sliding disk is inclined with its disk axis by a setting angle relative to the piston axis of the pistons and the setting angle of the sliding disk determines the displacement volume of the axial piston pump. To adjust the displacement volume of the axial piston pump and thus also to adjust the system pressure of the hydraulic fluid supplied by the axial piston pump, the control device then adjusts the setting angle of the sliding disk of the axial piston pump accordingly. This adjustment of the setting angle of the sliding disk of the axial piston pump can be carried out with significantly greater dynamics and correspondingly lower inertia than adjusting the rotary speed of a variable-speed hydraulic pump.

In the preferred embodiment of the invention, the hydraulically driven consumer is a pressing device for pressing the food product, as already briefly mentioned above. Depending on the type of food product to be pressed (e.g. raw ham, raw meat), the control device specifies a certain travel profile of the pressing device in accordance with a predetermined pressing recipe with a certain temporal progression of position, speed and acceleration of a pressing plate and the associated pressing force of the pressing device. For example, a certain pressing force should be maintained for a certain duration during a pressing process in order to achieve a good pressing result. The control device then calculates the required minimum value of the system pressure that must be supplied by the hydraulic pump in order to be able to carry out the desired pressing process, depending on the product-specific travel profile of the pressing device. The control device then controls the hydraulic pump in such a way that the hydraulic pump only supplies the required minimum value of the system pressure with a certain safety margin as required, but no more. In the case of an axial piston pump, the system pressure can be set by adjusting the displacement volume of the hydraulic pump.

In the preferred embodiment of the invention, the hydraulic pump (e.g. axial piston pump) is connected to the hydraulically driven consumer (e.g. drive cylinder of a pressing device) via a supply line. A return line runs from the hydraulically driven consumer to a return (e.g. hydraulic oil tank). The hydraulically driven consumer is controlled by a valve (e.g. proportional valve), which controls the hydraulic flow from the hydraulic pump through the supply line to the consumer on the one hand and the hydraulic flow from the consumer through the return line into the return on the other. The control device then adjusts this valve so that the actual process force of the pressing device matches the desired process force as closely as possible.

It should also be mentioned that a pressure measuring device is preferably provided, which measures at least one hydraulic pressure at the pressing device. The food-processing machine according to the invention preferably has two separate control loops, namely on the one hand a first control loop for controlling the desired process force and on the other hand a second control loop for controlling the system pressure of the hydraulic fluid.

The first control loop for force control extends from the pressure measuring device to a first controller, which activates the valve in the supply line or return line depending on the hydraulic pressure measured by the pressure measuring device so that the actual process force of the pressing device matches the desired process force as precisely as possible. For this purpose, the pressure measuring device preferably measures the hydraulic pressure in the supply line and in the return line via two pressure sensors and uses this to calculate the pressure difference that acts on a displaceable piston in the drive cylinder. The process force applied by the drive cylinder can then be calculated from this pressure difference.

The second control loop for regulating the system pressure of the hydraulic fluid also extends from the pressure measuring device on the consumer to a second controller, which adjusts the displacement volume of the hydraulic pump as required depending on the hydraulic pressure measured by the pressure measuring device so that the hydraulic pump only supplies the required minimum value of the system pressure with a certain safety margin, but no more.

The second control loop therefore ensures that there is always sufficient hydraulic fluid system pressure as required, while the first control loop ensures that the desired process force is set.

The control of the valve (e.g. proportional valve) in the supply line or return line is usually carried out according to a valve characteristic curve or according to a characteristic curve map, whereby the valve characteristic curve or the characteristic curve map is based on a certain system pressure of the hydraulic fluid. If the system pressure changes, the valve characteristic curve or the characteristic curve map must therefore also be adapted accordingly. The second control loop therefore preferably also has an actuator that adjusts the valve characteristic curve or the characteristic curve map of the first controller in the first control loop accordingly depending on the system pressure supplied by the hydraulic pump. This ensures that the proportional valve is controlled correctly even if the system pressure of the hydraulic fluid changes.

In the preferred embodiment of the invention, the pressing device comprises at least one pressing chamber in order to receive the food product during a pressing process. During a pressing process, at least one pressing plate is then displaced by a drive cylinder, wherein a piston is displaceable in the hydraulic drive cylinder, which acts on the pressing plate via a piston rod. It should be mentioned here that the piston rod of the hydraulic drive cylinder can act directly on the pressing plate. Alternatively, however, it is also possible for the piston rod of the drive cylinder to act indirectly on the press plate via kinematics. In this case, the supply line mentioned above opens into the bottom of the drive cylinder in order to extend the piston rod. The return line mentioned above, on the other hand, opens into the drive cylinder on the rod side, i.e. on the side of the piston rod. The pressure measuring device preferably has two pressure sensors, namely a first pressure sensor, which measures the hydraulic pressure in the drive cylinder on the base side or in the supply line, and a second pressure sensor, which measures the hydraulic pressure in the drive cylinder on the rod side or in the return line. The control device can now calculate the differential pressure acting on the piston of the drive cylinder from the two measured pressure values of the two pressure sensors, which can then be used to calculate the process force that the drive cylinder can apply. It should be noted here that the process force of the drive cylinder comprises the frictional force, the acceleration force (inertia force) and the actual pressing force with which the food product is pressed. The second controller in the control loop then adjusts the displacement volume of the hydraulic pump so that the hydraulic pump only supplies the required minimum value of the system pressure, but no more, with a certain safety margin.

In general, it should also be mentioned that the hydraulic pump can be driven by an electric motor.

The control device can then have a pulse-width modulator that receives a setpoint value for the hydraulic pressure and outputs a pulse-width modulated control signal on the output side. For example, such a pulse-width modulator can also have a so-called dither element, which impresses a dither signal onto the pulse-width modulated control signal in order to avoid the disruptive stick-slip effect. In addition, the pulse-width modulator can have a current controller on the output side, which outputs the pulse-width modulated control signal as a current signal.

It should also be mentioned that the control device in the food-processing machine according to the invention can have an electromechanical actuator, whereby the electromechanical actuator receives the pulse-width modulated control signal from the pulse-width modulator and adjusts the displacement volume of the hydraulic pump in accordance with the pulse-width modulated control signal in order to adjust the system pressure. For example, the electromechanical actuator can adjust the setting angle of the sliding disk of the axial piston pump, as briefly described above.

It should also be mentioned that the control device can have a limiting element that limits the rate of change in the system pressure of the hydraulic fluid. This dampens excessively rapid pressure changes.

In addition, the pressing device can have a so-called phase controller, which can distinguish between different phases of a pressing process. For example, the following phases of a pressing process can be distinguished:
Loading phase in which a food product is loaded into a pressing chamber,
Press positioning phase, in which at least one pressing plate is moved towards the food product in the pressing chamber,
Force build-up phase, in which a predetermined pressing force is built up to act on the food product,
Force holding phase, in which a predetermined pressing force is applied to the food product,
Relief phase, in which the pressing force acting on the food product is reduced, and
Unloading phase in which the pressed food product is removed from the pressing chamber.

The phase controller can then specify a minimum value for the system pressure in each of the individual phases of the pressing process, which must not be undershot under any circumstances, regardless of the demand-based calculation of the system pressure.

It has already been described above that the food-processing machine is preferably a pressing device. However, the principle according to the invention can also be used in other types of food-processing machines, for example in food-processing machines for forming or separating food products.

In a forming machine for forming so-called patties for hamburgers, the forming plate moves in and out (quickly) with the hydraulics on the one hand and the raw material (e.g. minced meat) is pumped towards the forming cavities (in the so-called pump box) with two hydraulic cylinders on the other.

In a separation machine, on the other hand, meat and bone residues are pressed through a perforated plate using a hydraulic cylinder.

Both machines (forming machines and separation machines) are driven by a hydraulic pump, so that the principle according to the invention can also be used for these types of machines.

Other advantageous embodiments of the invention are characterized in the dependent claims or are explained in more detail below together with the description of the preferred embodiments of the invention with reference to the figures.

### BRIEF DESCRIPTION OF THE DRAWINGS

FIG. 1 shows a schematic representation of a pressing device according to the invention for pressing food products.

FIG. 2 shows a control equivalent circuit diagram of the pressing device from FIG. 1.

FIGS. 3A and 3B show further details of the control of the pressing device according to the invention.

FIG. 4 shows a time diagram with the time progressions of the controlled system pressure and the position of the pressing plates of the pressing device during a pressing process.

### DETAILED DESCRIPTION OF THE DRAWINGS

In the following, the embodiment example shown in the drawings of a pressing device according to the invention is described, which is used for pressing a food product 1 (e.g. raw ham, raw meat), as is known per se from the prior art.

For this purpose, the pressing device has a pressing chamber 2, into which the food product 1 to be pressed can be placed during a pressing process. In the pressing chamber 2, the food product 1 can be pressed by at least one pressing plate 3, whereby the pressing plate 3 can be displaced in the direction of the double arrow by a hydraulic drive cylinder 4. A piston 5 is displaceable in the drive cylinder 4, whereby the piston 5 is connected to the pressing plate 3 via a piston rod 6 and can displace it. It should be noted here that the piston rod 6 can also be indirectly connected to the press plate 3 via kinematics not shown. It should also be mentioned that, for the sake of simplicity, only a single pressing axis is shown in the drawing with the pressing plate 3. In practice, however, the food product 1 is usually pressed in three pressing axes (length, height, width), which is not shown here for the sake of simplicity.

The hydraulic pressure for operating the drive cylinder 4 is generated by an axial piston pump 7, which pumps hydraulic oil into the drive cylinder 4 via a supply line 8 on the bottom side of the piston 5. The hydraulic pressure generated in the drive cylinder 4 via the supply line 8 therefore leads to the piston rod 6 being extended and thus to a pressing process.

A return line 9 branches off from the drive cylinder 4 on the rod side of the piston 5 and flows into a hydraulic oil tank 10 to collect the returned hydraulic oil.

The piston rod 6 with the press plate 3 is retracted in the opposite direction, in that the proportional valve 11 feeds the hydraulic oil into the drive cylinder 4 via the return line 9 on the rod side of the piston 5, so that the piston 5 is pushed to the left in the drawing.

A pressing process is controlled by a proportional valve 11, which controls the hydraulic flow through the supply line 8 and the return line 9.

The valve position of the proportional valve 11 is specified by a control device 12 in accordance with the invention, as described in detail below.

A pressure sensor 13 is located in the supply line 8, which measures a hydraulic pressure p_{Inlet} in the supply line 8. The measured hydraulic pressure p_{Inlet} is essentially the same as the hydraulic pressure in the drive cylinder 4 on the bottom side of the piston 5.

In addition, there is a further pressure sensor 14 in the return line 9 for measuring a hydraulic pressure p_{Return} in the return line 9. The measured hydraulic pressure p_{Return} is essentially the same as the hydraulic pressure in the drive cylinder 4 on the rod side of the piston 5.

The control device 12 can calculate the pressure difference acting on the piston 5 from the two measured pressure values p_{Inlet}, P_{Return}. This in turn can be used to calculate the process force F applied by the drive cylinder 4, taking into account the different pressure contact surfaces of the piston 5 on the base side on the one hand and on the rod side on the other. This process force F is the sum of the frictional force, the acceleration force and the actual pressing force acting on the food product 1.

Furthermore, the pressing device shown has a position sensor 15, which measures the position of the piston 5 and thus also of the pressing plate 3 and reports a corresponding position value x to the control device 12.

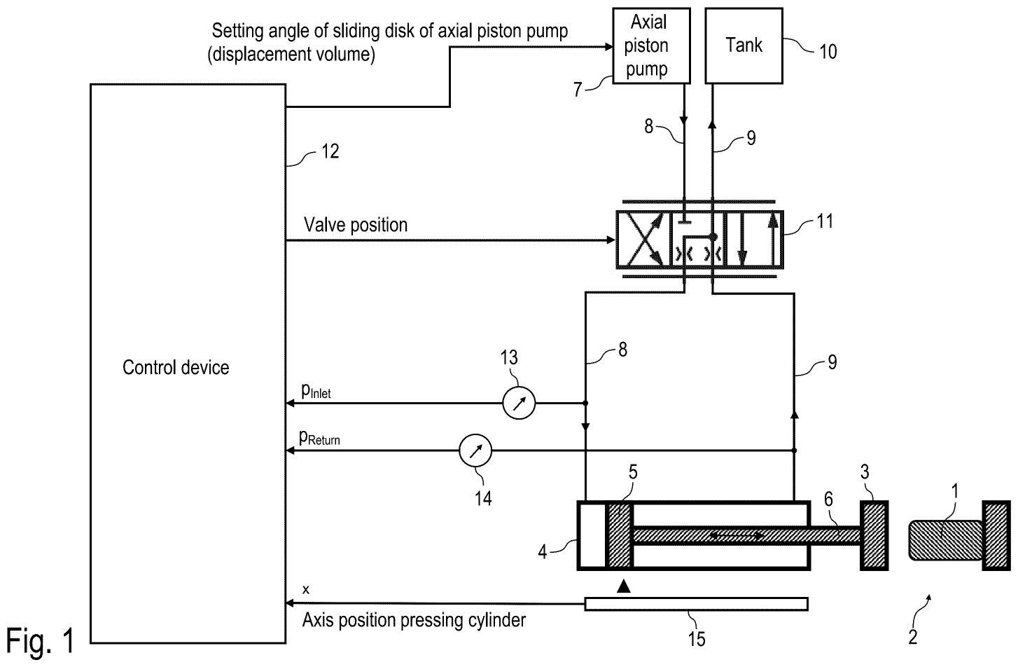

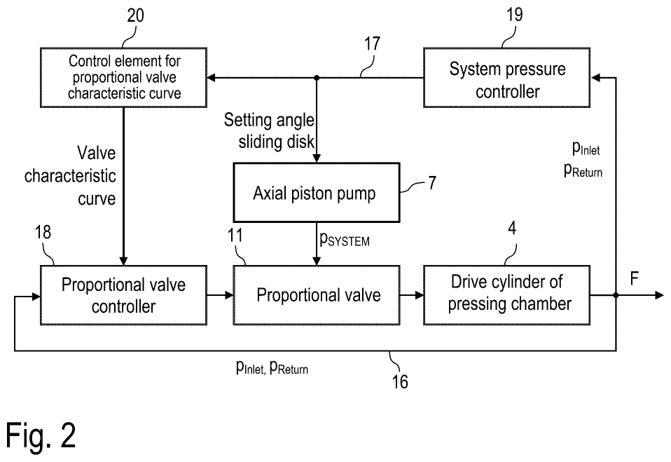

The simplified control equivalent circuit diagram according to FIG. 2 is now described below, whereby this equivalent circuit diagram illustrates the control processes in the control device 12 according to FIG. 1.

Thus, the control device 12 has two control loops 16, 17, whereby the control loop 16 is used to control the process force F, while the other control loop 17 is used to control the system pressure P_{SYSTEM}, which is supplied by the axial piston pump 7.

For force control, the control loop 16 measures the hydraulic pressure p_{Inlet} in the supply line 8 and the hydraulic pressure p_{Return} in the return line 9 and reports these measured pressure values to a proportional valve controller 18, which controls the proportional valve 11 according to a stored characteristic curve or according to a characteristic curve field so that the drive cylinder 4 generates the desired process force F.

The second control loop 17 has a system pressure controller 19, which has the task of regulating the system pressure p_{SYSTEM} of the hydraulic oil as required, whereby two control objectives are pursued. Firstly, the system pressure p_{SYSTEM} must be high enough to ensure that the required process force F can be applied by the drive cylinder 4. On the other hand, the system pressure P_{SYSTEM} Should be as low as possible so that the mechanical drive of the axial piston pump 7 is as energy-efficient as possible. The system pressure controller 19 therefore adjusts the adjustable displacement volume of the axial piston pump 7 so that both control objectives are achieved. For this purpose, the setting angle of the sliding disk of the axial piston pump 7 is adjusted, which leads to a corresponding change in the displacement volume of the axial piston pump 7.

If the system pressure p_{SYSTEM} changes, it must be ensured that the proportional valve controller 18 still controls the proportional valve 11 correctly, as this control is adapted for a specific system pressure. The second control loop 17 therefore has an actuator 20 which, when the system pressure P_{SYSTEM} is adjusted, also adjusts the valve characteristic curve or the characteristic curve field stored in the proportional valve controller 18 so that the force control in the first control loop 16 continues to function correctly even when the system pressure p_{SYSTEM} is adjusted.

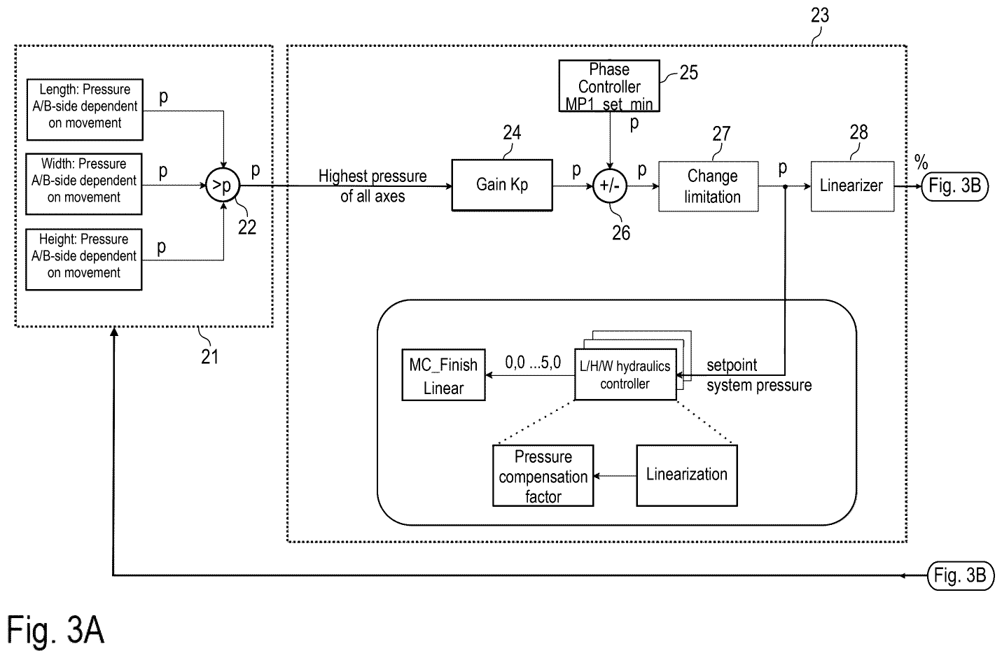

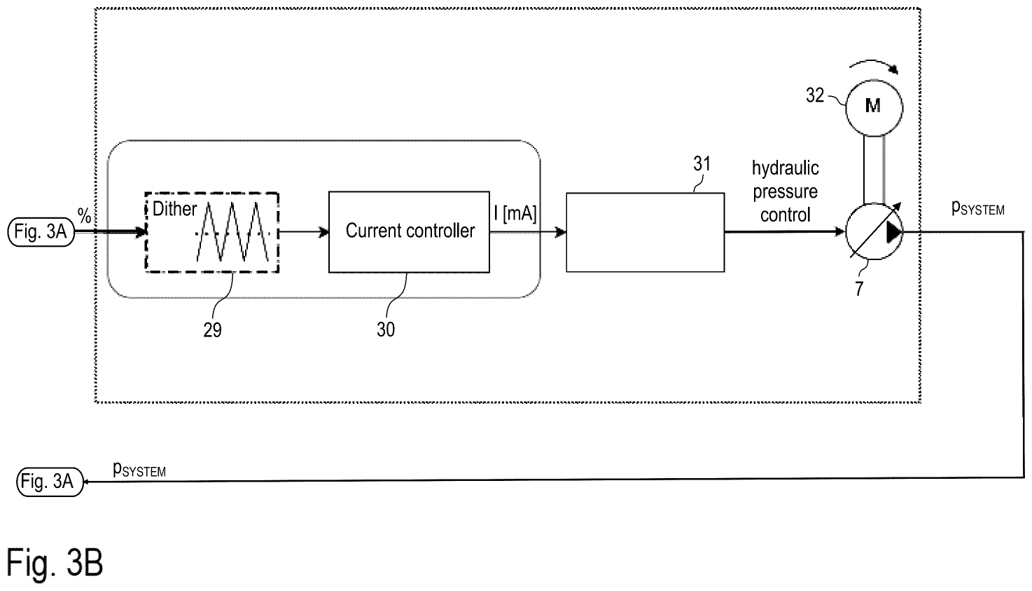

With reference to FIGS. 3A and 3B, further control and regulation details of the control device 12 are now described below.

The control device 12 has a control module 21 that calculates the required system pressure for each of the three pressing axes (length, width, height) and outputs the minimum required system pressure p by means of a comparator unit 22.

In a second control module 23, a safety factor is then first multiplied by the calculated minimum system pressure using an amplification element 24. This amplification is intended to ensure that the system pressure set later is always sufficient to apply the desired process force.

Furthermore, the control module 23 has a phase controller 25, which can distinguish between different phases of a pressing process and specifies a minimum required system pressure for each pressing phase. This minimum required system pressure is then taken into account by a computing unit 26, i.e. the minimum system pressure specified by the phase controller 25 is always maintained regardless of the system pressure required as needed.

In addition, the control module 23 has a limiting element 27 that limits the maximum rate of change of the system pressure in order to prevent jerky changes.

Next comes a linearizer 28, which transfers the required system pressure to a dither element 29. The dither element 29 has the task of preventing the disruptive slip-stick effect.

Next comes a current controller 30, which controls a servomotor 32 via an electromechanical actuator 31 in order to adjust the setting angle of the sliding disk of the axial piston pump 7, whereby the displacement volume of the axial piston pump 7 is adjusted.

In addition, the control module 23 contains further details which, however, are not essential to the invention and therefore need not be described in more detail or are immediately apparent from FIG. 3A.

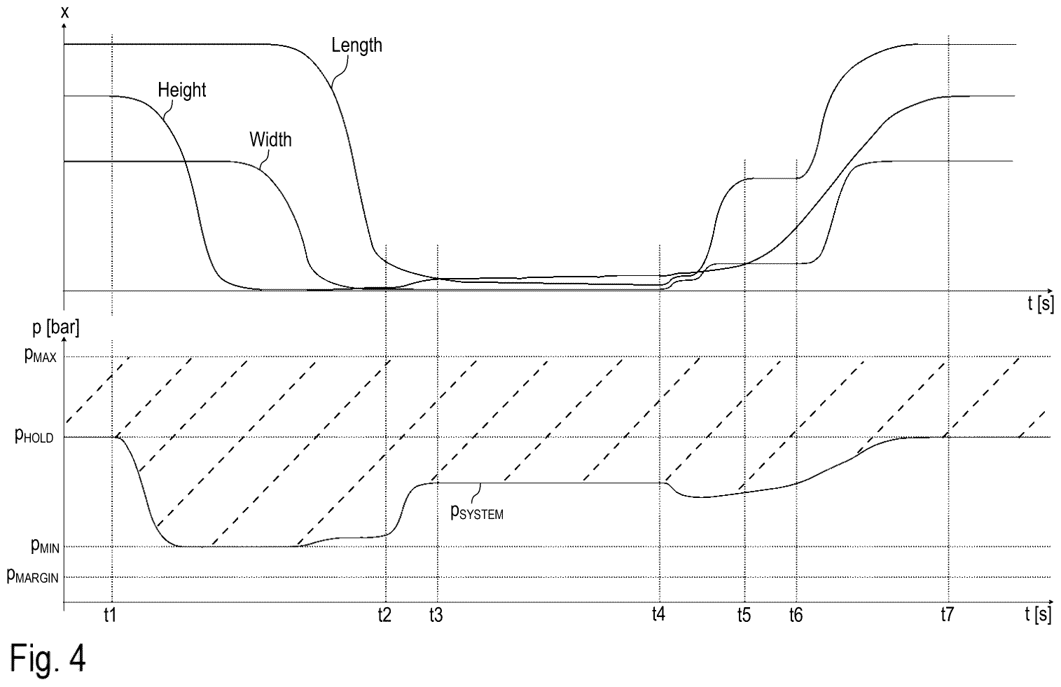

The time diagrams according to FIG. 4, which show the different time phases of a pressing process, are described below.

The upper time diagram shows the progression over time of the position x of the respective pressing plates in the pressing axes in terms of length, width and height.

The diagram below shows the associated time curve of the required system pressure p_{SYSTEM}, whereby the system pressure p_{SYSTEM} is readjusted depending on the requirements for the process force F to be applied. The period between t=t3 and t=t4 is a force holding phase in which a relatively high pressing force F must be maintained, for which a correspondingly high system pressure p_{SYSTEM} is required. Before the actual pressing process, on the other hand, a relatively low process force F is required, so that the system pressure p_{SYSTEM} can then be lowered accordingly in order to save drive energy for driving the axial piston pump 7.

The invention is not limited to the preferred embodiment example described above. Rather, a large number of variants and modifications are possible which also make use of the inventive concept and therefore fall within the scope of protection. In particular, the invention also claims protection for the subject matter and the features of the dependent claims independently of the claims referred to in each case and, in particular, also without the features of the main claim. The invention thus comprises various aspects of the invention, which enjoy protection independently of each other.

### LIST OF REFERENCE SIGNS

1 Food product in the pressing chamber
2 Press chamber
3 Pressing plate for pressing the food product in the pressing chamber
4 Drive cylinder for moving the pressing plate
Piston in the drive cylinder
6 Piston rod of the drive cylinder
7 Axial piston pump
8 Supply line from the axial piston pump to the drive cylinder
9 Return line from the drive cylinder into the tank
10 Hydraulic oil tank for returned hydraulic oil
11 Proportional valve
12 Control device for controlling the proportional valve and the axial piston pump
13 Pressure sensor for measuring the hydraulic pressure in the supply line
14 Pressure sensor for measuring the hydraulic pressure in the return line
15 Position sensor for measuring the position of the piston
16 Control loop for regulating the process force
17 Control loop for regulating the hydraulic oil system pressure supplied by the axial piston pump
18 Proportional valve controller for controlling the proportional valve
19 System pressure controller for setting the system pressure by adjusting the setting angle of the sliding disk of the axial piston pump Actuator for adapting the valve characteristic curve or characteristic curve field of the
20 proportional valve controller to the system pressure
21 Control module for determining the required system pressure of the three pressing axes
22 Comparator unit for determining the maximum system pressure required in the three pressing axes
23 Control module
24 Amplifier for amplifying the required system pressure with a safety factor
25 Phase controller
26 Computing unit
27 Limiting element for limiting the dynamic change in system pressure
28 Linearizer
29 Dither elements to avoid the slip-stick effect
30 Current controller
31 Actuator
32 Servomotor for adjusting the setting angle of the sliding disk of the axial piston pump
F Process force of the drive cylinder (pressing force+friction force+acceleration force)
P_{SYSTEM} System pressure of the hydraulic oil
P_{Inlet} Hydraulic pressure in the supply line
P_{Return} Hydraulic pressure in the return line
x Position of the piston in the drive cylinder

1. A food-processing machine for processing a food product, with
a) at least one hydraulically driven consumer,
b) a hydraulic pump which is adapted to deliver a hydraulic fluid for driving the consumer and to supply a specific system pressure of the hydraulic fluid, and
c) a control device for specifying a desired mechanical power of the consumer, wherein a specific minimum value of the system pressure is required to achieve the desired mechanical power of the consumer,
d) wherein the control device is adapted to adjust the system pressure supplied by the hydraulic pump as a function of the desired mechanical power of the consumer as required in such a way that the hydraulic pump supplies only the required minimum value of the system pressure with a certain safety margin, but no more, in order to save drive energy for driving the hydraulic pump.

2. The food-processing machine according to claim 1, wherein
a) the hydraulic pump has an adjustable displacement volume, and
b) the control device is adapted to adjust the displacement volume of the hydraulic pump in order to set the system pressure of the hydraulic fluid supplied by the hydraulic pump.

3. The food-processing machine according to claim 1, wherein
a) the hydraulic pump has an adjustable rotary speed, and
b) the control device is adapted to adjust the rotary speed of the hydraulic pump in order to set the system pressure of the hydraulic fluid supplied by the hydraulic pump.

4. The food-processing machine according to claim 2, wherein
a) the hydraulic pump is an axial piston pump, with
a1) several pistons, each of which is axially displaceable along a piston axis and
a2) a sliding disk that moves the pistons axially,
a3) wherein the sliding disk is inclined with its disk axis by a setting angle relative to the piston axis of the pistons and the setting angle of the sliding disk determines the displacement volume of the axial piston pump, and
b) the control device is adapted to adjust the setting angle of the sliding disk of the axial piston pump in order to set the displacement volume of the axial piston pump and thus to set the system pressure of the hydraulic fluid supplied by the axial piston pump.

5. The food-processing machine according to claim 1, wherein
a) the hydraulically driven consumer is a pressing device for pressing the food product, and
b) the control device, depending on the type of food product to be pressed, specifies a specific travel profile of the pressing device in accordance with a predetermined pressing recipe, with a specific progression of position, speed and acceleration of a pressing plate and/or a pressing force of the pressing device,
c) the control device is adapted to calculate the required minimum value of the system pressure, which must be supplied by the hydraulic pump, as a function of the predetermined travel profile of the pressing device, and
d) the control device is adapted to control the hydraulic pump in such a way that the hydraulic pump only supplies the required minimum value of the system pressure as required with a specific safety margin, but no more.

6. The Food-processing machine according to claim 5, further comprising
a) a return for receiving recirculated hydraulic fluid,
b) a supply line from the hydraulic pump to the hydraulically driven consumer,
c) a return line from the hydraulically driven consumer into the return, and
d) a valve for controlling the hydraulic flow
d1) from the hydraulic pump through the supply line to the consumer and
d2) from the consumer through the return line into the return,
e) wherein the control device is adapted to actuate the valve in such a way that the actual process force of the pressing device matches the desired process force as precisely as possible.

7. The food-processing machine according to claim 6, further comprising
a) a pressure measuring device for measuring at least one hydraulic pressure at the pressing device,
b) a first control loop for controlling the process force generated by the pressing device, the first control loop extends from the pressure measuring device to a first controller which actuates the valve as a function of the hydraulic pressure measured by the pressure measuring device in such a way that the actual process force of the pressing device matches the desired process force as precisely as possible, and
c) a second control loop for controlling the system pressure of the hydraulic fluid supplied by the hydraulic pump, wherein the second control loop extends from the pressure measuring device to a second controller, which is adapted to adjust the displacement volume of the hydraulic pump as required as a function of the hydraulic pressure measured by the pressure measuring device in such a way that the hydraulic pump supplies only the required minimum value of the system pressure with a certain safety margin, but no more.

8. The food-processing machine according to claim 6, wherein
a) the first controller in the first control loop is adapted to control the valve as a function of the hydraulic pressure measured by the pressure measuring device in accordance with a valve characteristic curve or in accordance with a characteristic curve map, and
b) the second control loop contains an actuator which is adapted to adjust the valve characteristic curve or the characteristic curve field of the first controller in the first control loop as a function of the system pressure supplied by the hydraulic pump.

9. The food-processing machine according to claim 6, wherein
a) the pressing device comprises at least one pressing chamber for receiving the food product during a pressing operation,
b) the pressing device comprises at least one drive cylinder with a piston which can be displaced in the drive cylinder and acts on a pressing plate via a piston rod in order to press the food product in the pressing chamber,
c) the piston rod of the drive cylinder optionally acts directly on the pressing plate or indirectly via kinematics,
d) the supply line opens into the drive cylinder at the bottom in order to extend the piston rod,
e) the return line opens into the drive cylinder on the rod side,
f) the pressure measuring device comprises a first pressure sensor which measures the hydraulic pressure in the drive cylinder on the base side or in the inlet line,
g) the pressure measuring device comprises a second pressure sensor which measures the hydraulic pressure in the drive cylinder on the rod side or in the return line,
h) the control device uses the hydraulic pressures measured in the drive cylinder on the base side and on the rod side and the desired process force of the drive cylinder to calculate the minimum required system pressure, which must be supplied by the hydraulic pump so that the pressing device can apply the predetermined process force, and
i) the second controller in the second control loop is adapted to adjust the displacement volume of the hydraulic pump such that the hydraulic pump only supplies the required minimum value of the system pressure as required with a certain safety margin, but no more.

10. The food-processing machine according to claim 1, wherein the hydraulic pump is driven by an electric motor.

11. The food-processing machine according to claim 1, wherein the control device comprises a pulse-width modulator which is adapted to receive a setpoint value for the hydraulic pressure and to output a pulse-width modulated control signal on the output side.

12. The food-processing machine according to claim 11, wherein the pulse-width modulator comprises a dither element which is adapted to impose a dither signal on the pulse-width modulated control signal in order to avoid a stick-slip effect.

13. The food-processing machine according to claim 11, wherein the pulse-width modulator preferably comprises a current controller on the output side, which is adapted to output the pulse-width modulated control signal as a current signal.

14. The food-processing machine according to claim 11, wherein the control device comprises an electromechanical actuator, wherein the electromechanical actuator is adapted to receive the pulse-width modulated control signal from the pulse-width modulator and to adjust the displacement volume of the hydraulic pump according to the pulse-width modulated control signal in order to adjust the hydraulic pressure.

15. The food-processing machine according to claim 1, wherein the control device comprises a limiting member which is adapted to limit the rate of pressure change of the system pressure of the hydraulic fluid.

16. The food-processing machine according to claim 1, wherein
a) the food-processing machine is a pressing device and comprises a phase controller which is adapted to recognize and distinguish several of the following phases of a pressing process:
a1) Loading phase in which a food product is loaded into a pressing chamber,
a2) Press positioning phase, in which at least one pressing plate is moved towards the food product in the pressing chamber,
a3) Force build-up phase, in which a predetermined pressing force is built up to act on the food product,
a4) Force holding phase, in which a predetermined pressing force is maintained, which acts on the food product,
a5) a release phase in which the pressing force acting on the food product is reduced, and
a6) an unloading phase in which the pressed food product is removed from the pressing chamber, and
b) the phase controller is adapted to specify a minimum value for the system pressure in each of the individual phases of the pressing process.

17. The food-processing machine according to claim 1, wherein the food-processing machine is a food forming machine for forming the food product.

18. The food processing machine according to claim 1, wherein the food-processing machine is a food separating machine for separating food products.
